(19) United States
(12) Patent Application Publication
(10) Pub. No.: US 2024/0391017 A1
(43) Pub. Date: Nov. 28, 2024

(54) FRICTION STIR WELDING TOOL ASSEMBLY WITH TEMPERATURE SENSING ABILITY

(71) Applicant: EVERWELL ADVANCED TECHNOLOGY CO., LTD, Taoyuan City (TW)

(72) Inventors: Chih-Wei HUANG, Taoyuan City (TW); Huan-Chieh YEN, Taoyuan City (TW); Chien-Hsun HUANG, Taoyuan City (TW)

(21) Appl. No.: 18/590,024

(22) Filed: Feb. 28, 2024

(30) Foreign Application Priority Data
May 26, 2023 (TW) 112119613

(51) Int. Cl. B23K 20/12

(52) U.S. Cl. CPC B23K 20/1245; B23K 20/123

(57) ABSTRACT

A friction stir welding tool assembly includes a female tool member, a stirring tool member, a temperature-sensing probe and a bolt. The female tool member has a friction-generating shoulder for generating friction with two workpieces, an axial through hole and a radial threaded hole. The stirring tool member has a fixed section and a stirring section. The fixed section is inserted in the axial through hole. The stirring section is extended from the friction-generating shoulder in a direction pointing away from the axial through hole. The stirring section is adapted to be driven into a gap between the two workpieces for stirring. The temperature-sensing probe is adapted to contact and sense a working temperature of the stirring tool member. The bolt is threaded in the radial threaded hole to abut against the fixed section.

### BACKGROUND OF THE INVENTION

### 1. Technical Field

The present invention relates to a friction stir welding tool assembly.

### 2. Description of Related Art

Friction stir welding is carried out by driving the pin of a friction stir welding tool into a butt joint between two workpieces and then moving the tool along the butt joint while rotating the tool. During the process, friction is generated by the rotation of the tool, and the mechanical kinetic energy of the tool is converted into thermal energy such that the portions of the two workpieces that are subjected to friction are plastically deformed by the heat. As the tool continues moving and rotating, the materials of the plastically deformed portions of the two workpieces are stirred and the workpieces are joined together as a result.

The quality of friction stir welding is related to the working temperature during welding. Therefore, how to monitor the working temperature during the stir welding process is worthy of attention.

### BRIEF SUMMARY OF THE INVENTION

The primary objective of the present invention is to provide a friction stir welding tool assembly with temperature sensing ability.

To achieve the foregoing and other objectives, the present invention provides a friction stir welding tool assembly, which includes a female tool member, a stirring tool member, a temperature-sensing probe and a bolt. The female tool member has a friction-generating shoulder for generating friction with two workpieces, an axial through hole and a radial threaded hole. The axial through hole is extended through a center of the friction-generating shoulder along a central axis of the female tool member. The radial threaded hole is extended in a radial direction of the female tool member and is in communication with the axial through hole. The stirring tool member has a fixed section and a stirring section. The fixed section is inserted in the axial through hole. The stirring section is extended from the friction-generating shoulder in a direction pointing away from the axial through hole. The stirring section is adapted to be driven into a gap between the two workpieces for stirring. The temperature-sensing probe is adapted to contact and sense a working temperature of the stirring tool member. The bolt is threaded in the radial threaded hole to abut against the fixed section.

The other features and effects of the present invention are stated further below.

### BRIEF DESCRIPTION OF THE SEVERAL VIEWS OF THE DRAWINGS

FIG. 1 is a perspective view of the two-piece tool in an embodiment of the present invention.

FIG. 2 is an exploded view of the two-piece tool in FIG. 1.

FIG. 3 is a sectional view of the two-piece tool in FIG. 1.

FIG. 4 shows how the embodiment mentioned in the brief description of FIG. 1 is used in a friction stir welding process.

FIG. 5 shows how the embodiment mentioned in the brief description of FIG. 1 is used in another friction stir welding process.

### DETAILED DESCRIPTION OF THE INVENTION

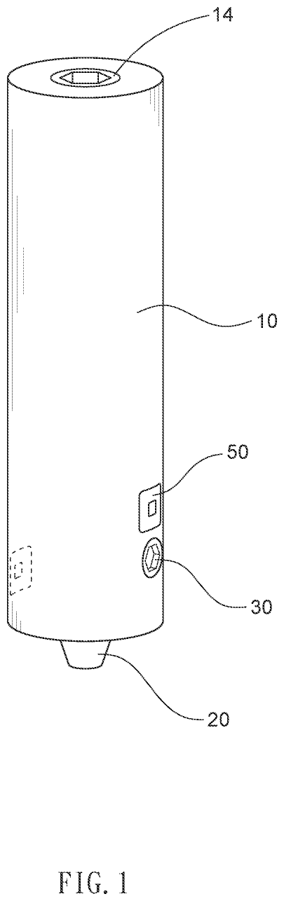

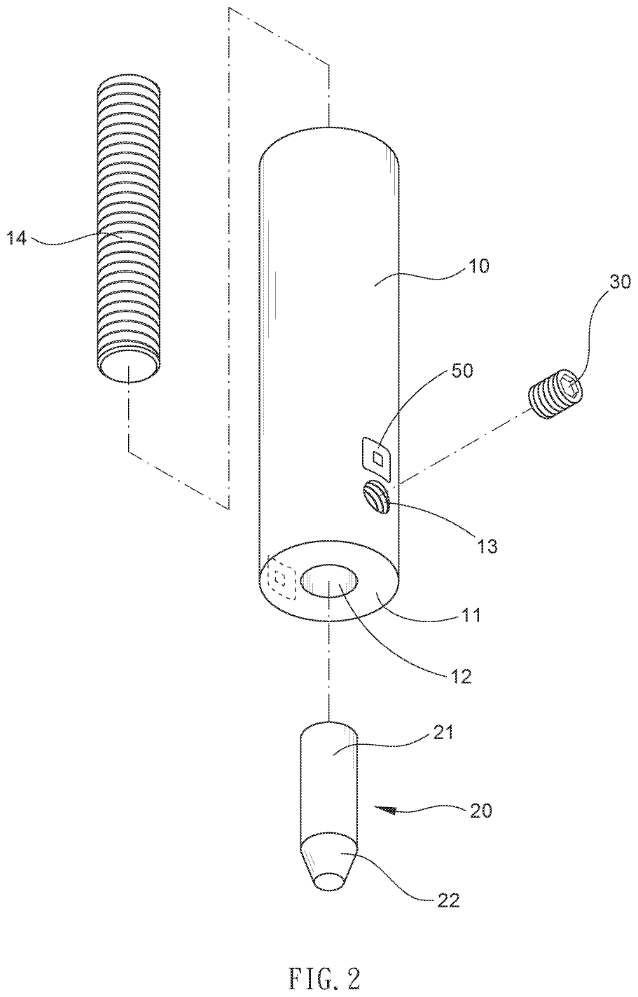

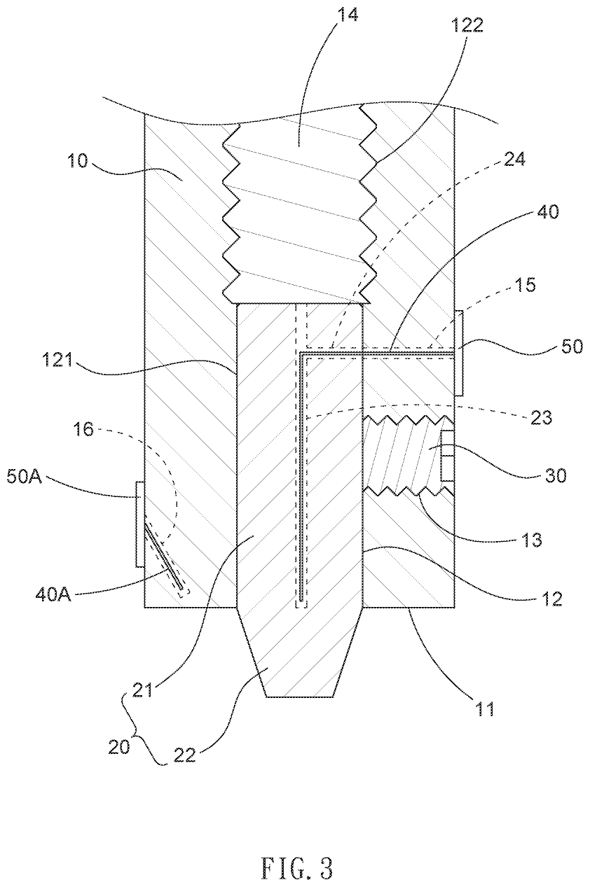

Referring to FIG. 1 to FIG. 4, the friction stir welding tool assembly 1 according to an embodiment of the present invention has a friction stir welding tool holder 2 and a two-piece tool 3. The friction stir welding tool holder 2 is mounted on the processing shaft of a machine tool, and the two-piece tool 3 is mounted in the friction stir welding tool holder 2 in order to perform a friction stir welding process on two workpieces W.

More specifically, the friction stir welding tool assembly 1 includes a female tool member 10, a stirring tool member 20, a bolt 30, a temperature-sensing probe 40, and a wireless transmitter 50. The female tool member 10 and the stirring tool member 20 are the major parts of the two-piece tool 3.

The female tool member 10 has a friction-generating shoulder 11 for generating friction with the two workpieces W, an axial through hole 12, a radial threaded hole 13, and a set screw 14. The axial through hole 12 extends through the center of the friction-generating shoulder 11 along the central axis of the female tool member 10. The axial through hole 12 has a smooth-wall section 121 adjacent to the friction-generating shoulder 11 and a threaded section 122 located away from the friction-generating shoulder 11. The set screw 14 is threadedly provided in the threaded section 122. The radial threaded hole 13 extends in a radial direction of the female tool member 10 and is in communication with the axial through hole 12.

The stirring tool member 20 has a fixed section 21 and a stirring section 22. The fixed section 21 is inserted in the smooth-wall section 121 of the axial through hole 12 such that one end of the fixed section 21 abuts against the set screw 14. The depth to which the fixed section 21 is inserted into the axial through hole 12 can be fine-tuned with the set screw 14. The stirring section 22 extends from the friction-generating shoulder 11 in a direction pointing away from the axial through hole 12. The stirring section 22 is configured to be driven into the gap between the two workpieces W to stir the plasticized workpiece material and thereby weld the two workpieces W together. Depending on the material properties (e.g., the melting point) of the workpieces W, among other considerations, the female tool member 10 and the stirring tool member 20 may be made of, for example, but not limited to, ceramic, polycrystalline cubic boron nitride, a tungsten-rhenium alloy, carbon steel, high tensile steel, a titanium alloy, titanium or a copper alloy. One of the major functions of the female tool member 10 in a friction stir welding process is to generate friction and the resulting heat and one of the major functions of the stirring tool member 20 in a friction stir welding process is to stir the plasticized workpiece material. In other words, the female tool member 10 and the stirring tool member 20 do not have exactly the same functions. In a feasible embodiment, therefore, the material of the female tool member 10 may be different from that of the stirring tool member 20 in order to meet both functional and cost-reduction requirements.

The bolt 30 is threadedly provided in the radial threaded hole 13, abuts against the fixed section 21 and thereby fixes the stirring tool member 20 to the female tool member 10.

The temperature-sensing probe 40 is configured to contact and sense the working temperature of, the stirring tool member 20. The stirring tool member 20 has an axial probe-receiving hole 23 and a radial probe-receiving hole 24 and the female tool member 10 has a probe-receiving hole 15. The radial probe-receiving hole 24 is connected between and in communication with, the axial probe-receiving hole 23 and the probe-receiving hole 15. The temperature-sensing probe 40 is configured to be inserted in the axial probe-receiving hole 23, the radial probe-receiving hole 24, and the probe-receiving hole 15 to monitor if the working temperature of the stirring tool member 20 falls in a preset working temperature range.

The wireless transmitter 50 is electrically connected to the temperature-sensing probe 40 and is configured to transmit the temperature sensed by the temperature-sensing probe 40 to an external controller or computation system. The wireless transmitter 50 may be provided, for example, on a lateral side of the female tool member 10 but is not necessarily so located.

In this embodiment, there is another temperature-sensing probe 40A and another wireless transmitter 50A, and the female tool member 10 further has a near-shoulder probe-receiving hole 16. The near-shoulder probe-receiving hole 16 extends from the outer peripheral wall of the female tool member 10 to a position adjacent to the friction-generating shoulder 11. The temperature-sensing probe 40A is inserted in the near-shoulder probe-receiving hole 16 and is electrically connected to the wireless transmitter 50A to detect the working temperature of the friction-generating shoulder 11.

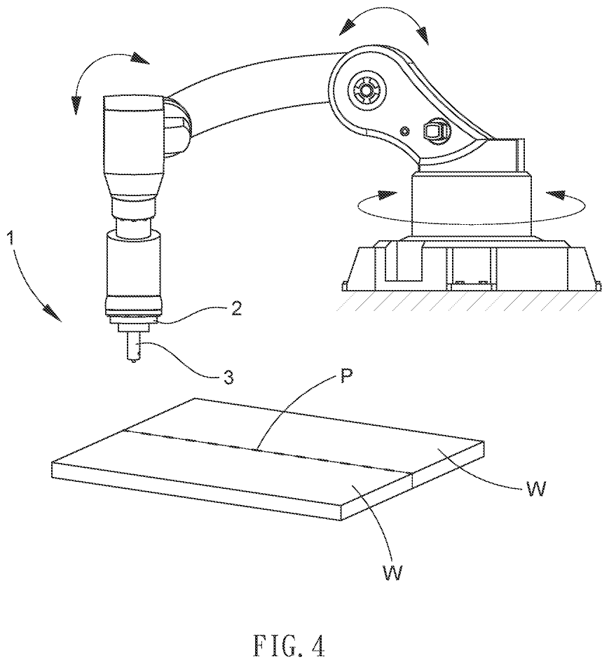

Referring to FIG. 4, the friction stir welding process referred to herein includes using the friction stir welding tool assembly 1 to perform friction stirring on the two workpieces W along a welding path P and during the friction stir welding process, the real-time feed rate of the friction stir welding tool assembly 1 is determined by the following equation:

$${FR}_{p} = {FR}_{o} \times ( 1 + ( \frac{D}{L} \times α ) )$$

where FRₚ is the real-time feed rate, i.e., the speed at which the friction stir welding tool assembly 1 is moved along the welding path P when the friction stir welding tool assembly 1 is at its current position along the welding path P; FR₀ is the speed at which the friction stir welding tool assembly 1 is moved along the welding path P when the friction stir welding tool assembly 1 is at the starting point of the welding path P; D is the distance for which the friction stir welding tool assembly 1 has been moved from the starting point along the welding path P; L is the total length of the welding path P; and a is a parameter set according to at least one welding property of the friction stir welding process.

As the friction stir welding process progresses, the total thermal energy supplied to the two workpieces W accumulates gradually. Given that many workpieces are good thermal conductors, the real-time feed rate determined by the above equation is characterized in that the closer the friction stirring is to the end, the higher the real-time feed rate. Such a real-time feed rate has three major advantages: (1) the total time of the friction stir welding process can be shortened in comparison with that resulting from a conventional feed rate; (2) the power consumed by the friction stir welding process can be reduced in comparison with that resulting from a conventional feed rate, and (3) the welding quality of those workpiece portions along the second half of the welding path will not be adversely affected by an excessive increase in temperature. Moreover, as the thermal conductivity of the workpiece W varies with the workpiece material, the aforesaid at least one welding property includes the thermal conductivity of the workpiece W. The higher the thermal conductivity of the workpieces W, the greater the value at which the parameter α should be set and the lower the thermal conductivity of the workpieces W, the smaller the value at which the parameter α should be set.

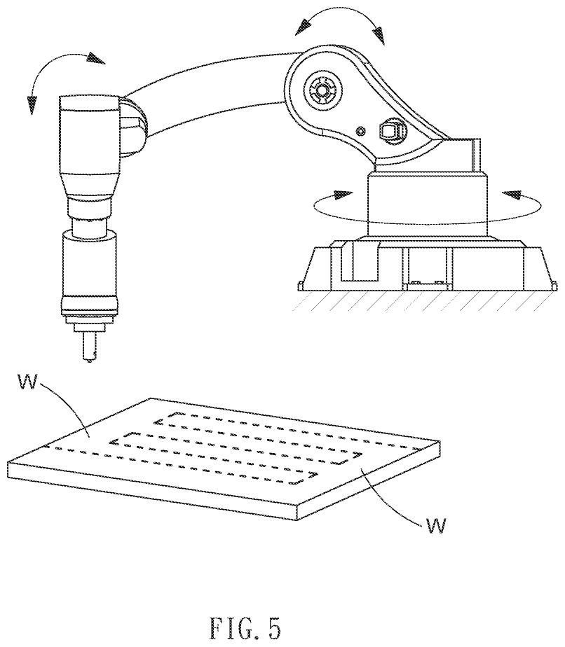

The increase in temperature of the workpieces W during a friction stir welding process may be attributable to other factors than the thermal conductivity of the workpieces W. For example, the welding paths shown in FIG. 4 and FIG. 5 are different in that the welding path in FIG. 4 is much shorter than the welding path in FIG. 5, so it can be expected that the total thermal energy supplied to the workpieces W in FIG. 5 during the friction stir welding process will be higher than that supplied to the workpieces W in FIG. 4. In view of this, the aforesaid at least one welding property may further include the ratio of the volume of those workpiece regions where friction stirring takes place to the total volume of the two workpieces (hereinafter referred to as the welding volume ratio for short). Since the welding volume ratio of the workpieces W in FIG. 5 is higher than that of the workpieces W in FIG. 4, the parameter α set for the friction stir welding process shown in FIG. 5 will be greater than that set for the friction stir welding process shown in FIG. 4. In other feasible embodiments, the at least one welding property may also include factors such as, but not limited to, the rotation speed of the friction stir welding tool assembly and the upsetting force applied to the two workpieces by the friction stir welding tool assembly.

What is claimed is:

1. A friction stir welding tool assembly with temperature sensing ability comprising:
a female tool member, having a friction-generating shoulder for generating friction with two workpieces, an axial through hole and a radial threaded hole, the axial through hole being extended through a center of the friction-generating shoulder along a central axis of the female tool member, the radial threaded hole being extended in a radial direction of the female tool member and being in communication with the axial through hole;
a stirring tool member, having a fixed section and a stirring section, the fixed section being inserted in the axial through hole, the stirring section being extended from the friction-generating shoulder in a direction pointing away from the axial through hole, the stirring section being adapted to be driven into a gap between the two workpieces for stirring;
a temperature-sensing probe, being adapted to contact and sense a working temperature of the stirring tool member; and
a bolt, being threaded in the radial threaded hole to abut against the fixed section.

2. The friction stir welding tool assembly of claim 1, further comprising a wireless transmitter electrically connected to the temperature-sensing probe.

3. The friction stir welding tool assembly of claim 2, wherein the wireless transmitter is disposed on the female tool member.

4. The friction stir welding tool assembly of claim 1, wherein the axial through hole has a smooth-wall section adjacent to the friction-generating shoulder and a threaded section located away from the friction-generating shoulder, the female tool member further has a set screw threaded in the threaded section, the set screw is adapted to abut against an end of the fixed section to adjust a depth to which the fixed section is inserted into the axial through hole.

5. The friction stir welding tool assembly of claim 1, wherein the stirring tool member has an axial probe-receiving hole and a radial probe-receiving hole, the female tool member has a probe-receiving hole, the radial probe-receiving hole is connected between and in communication with the axial probe-receiving hole and the probe-receiving hole, the temperature-sensing is inserted in the axial probe-receiving hole, the radial probe receiving hole and the probe-receiving hole.
